(19) United States
(12) Patent Application Publication
(10) Pub. No.: US 2002/0036850 A1
(43) Pub. Date: Mar. 28, 2002

(54) Enhanced short disc drive self test using historical logs

(75) Inventors: Thomas R. Lenny, Longmont, CO (US); James Arthur Herbst, Longmont, CO (US); Jonathan William Haines, Lafayette, CO (US)

Correspondence Address: MERCHANT & GOULD P.C., P.O. Box 2903, Minneapolis, MN, 55402-0903, US

(73) Assignee: Seagate Technologies LLC

(21) Appl. No.: 09/892,064

(22) Filed: Jun. 25, 2001

Related U.S. Application Data
(60) Provisional application No. 60/236,318, filed on Sep. 28, 2000.

(51) Int. Cl. G11B 27/36

(52) U.S. Cl. 360/31

(57) ABSTRACT

An apparatus, modules, means, and computer readable media for and a method of diagnosing a failed disc drive are disclosed. A disc drive is operably connectable to a host computer and has a data storage disc. A portion of the disc is a Critical Event Log storage area for storing a Critical Event Log and another portion of the disc is an ATA Error Log storage area for storing an ATA Error Log. A disc drive interface provides a data communication path between the disc drive and a host computer. Firmware in the disc drive stores the Enhanced Short DST module and performs Enhanced Short DST upon receiving a run diagnostics command from the host computer. The firmware is operably connected to the data storage disc and the disc drive interface. The Enhanced Short DST determines a disc drive failure by examining data stored in at least the Critical Event Log and the ATA Error Log. The Critical Event Log records a critical event generated during a normal disc drive operation where the critical event is predefined information related to disc drive operations. The Critical Event Log further records information reported by a SWAT. The SWAT transparently performs self-authentication of data written to the data storage disc and reports information characterizing failed read commands. The ATA Error Log records errors generated when the disc drive unsuccessfully performs a command issued by the host computer.

### RELATED APPLICATIONS

This application claims priority of U.S. provisional application Ser. No. 60/236,318, filed on Sep. 28, 2000 and titled “ENHANCED SHORT DRIVE TEST USING HISTORICAL LOGS.”

### FIELD OF THE INVENTION

This application relates generally to a diagnostics test for detecting a disc drive failure by examining the historical logs of the disc drive that stores events and errors while the disc drive is in use and more particularly the historical logs include a Critical Event Log and an ATA Error Log (also known as an ATA SMART Error Log).

### BACKGROUND OF THE INVENTION

Disc drives are data storage devices that store digital data in magnetic form on a rotating storage medium called a disc. Modern disc drives comprise one or more rigid discs that are coated with a magnetizable medium and mounted on the hub of a spindle motor for rotation at a constant high speed. Each surface of a disc is divided into several thousand tracks that are tightly-packed concentric circles similar in layout to the annual growth rings of a tree. The tracks are typically numbered starting from zero at the track located outermost the disc and increasing for tracks located closer to the center of the disc. Each track is further broken down into sectors and servo bursts. A sector is normally the smallest individually addressable unit of information stored in a disc drive and typically holds 512 bytes of information plus a few additional bytes for internal drive control and error detection and correction. This organization of data allows for easy access to any part of the discs. A servo burst is a particular magnetic signature on a track, which facilitates positioning of heads over tracks.

Generally, each of the multiple discs in a disc drive has associated with it two heads (one adjacent the top surface of the disc, and another adjacent the bottom) for reading and writing data to a sector. A typical disc drive has two or three discs. This usually means there are four or six heads in a disc drive carried by a set of actuator arms. Data is accessed by moving the heads from the inner to outer part of the disc (and vice-versa) driven by an actuator assembly. The heads that access sectors on discs are locked together on the actuator assembly. For this reason, all the heads move in and out together and are always physically located at the same track number (e.g., it is impossible to have one head at track 0 and another at track 500). Because all the heads move together, each of the tracks on all discs is known as a cylinder for reasons that these tracks form a cylinder since they are equal-sized circles stacked one on top of the other in space. So, for example, if a disc drive has four discs, it would normally have eight heads, and a cylinder number 680 would be made up of a set of eight tracks, one per disc surface, at track number 680. Thus, for most purposes, there is not much difference between tracks and cylinders since a cylinder is basically a set of all tracks whereat all the heads are currently located.

As with any data storage and retrieval, data integrity is critical. Oftentimes, for various reasons such as defective media, improper head positioning, extraneous particles between the head and media, or marginally functioning components, disc drives may record or read data incorrectly to or from the disc. For reasons such as predicting imminent disc drive failure, disc drive testing, and evolutionary disc drive improvement, it is valuable to characterize a disc drive's operating parameters; it is particularly useful to characterize unsuccessful reads and writes.

Disc drives will inevitably fail at the end of a long period of normal operations. As a result, the associated computer system will be down while the disc drive is replaced. Additionally, the disc drive failure may cause the loss of some or all of the data stored in the disc drive. While much of the data stored in the failed disc drive may be recoverable, the recovery of such data may be both costly and time consuming.

In today's field of mass storage device diagnostics, the diagnostics tests are run at the time of a suspected problem. These diagnostics tests may be software that resides in a host computer, which issues commands to the drive to discover problems related to disc drive operations. Alternatively, the diagnostics tests may be embedded in a firmware of the disc drive and initiated by a command from the host computer. The ATA-5 specification describes two levels of diagnostic tests that a host computer can instruct the disc drive to execute: Short Disc Drive Self-Test (Short DST) and Enhance Disc Drive Self-Test (Enhanced DST). The Enhanced DST accurately distinguishes good and bad disc drives but does not execute the test quickly enough for frequent uses. The Short DST takes less than two minutes to complete the diagnostics test, but unfortunately this quick test tends to indicate an unacceptable number of false negatives (i.e. bad disc drives devices being reported as good disc drives). Accordingly, there is a need for a diagnostics test that can determine a disc drive failure with accuracy equaling that of the Enhanced DST and that can be performed in about the same time to complete the Short DST.

### SUMMARY OF THE INVENTION

Against this backdrop the present invention has been developed. A disc drive is operably connectable to a host computer and has a data storage disc. A portion of the disc is a Critical Event Log storage area for storing a Critical Event Log and another portion of the disc is an ATA Error Log storage area for storing an ATA Error Log (also known as an ATA SMART Error Log). A disc drive interface provides a data communication path between the disc drive and a host computer. Firmware in the disc drive stores Enhanced Short DST module and performs Enhanced Short DST upon receiving a run diagnostics command from the host computer. The firmware is operably connected to the data storage disc and the disc drive interface. The Enhanced Short DST determines a disc drive failure by examining data stored in at least the Critical Event Log and the ATA Error Log. The Critical Event Log records a critical event generated during a normal disc drive operation where the critical event is predefined information related to disc drive operations. This Critical Event Log might include information about industry standard operations such as sector reallocations or events covered by other patents such as SWAT. SWAT transparently performs self-authentication of data written to the data storage disc and reports information characterizing failed write commands. The ATA Error Log records errors generated when the disc drive unsuccessfully performs a command issued by the host computer. These and various other features as well as advantages which characterize the present invention will be apparent from a reading of the following detailed description and a review of the associated drawings.

### BRIEF DESCRIPTION OF THE DRAWINGS

FIG. 1 is a plan view of a disc drive incorporating a preferred embodiment of the present invention showing the primary internal components.

FIG. 2 is a simplified block diagram of a disc drive and its connection to the host computer system including a servo system with which the present invention is particularly useful.

FIG. 3 is an enhanced DST flow chart in accordance with a preferred embodiment of the present invention.

### DETAILED DESCRIPTION

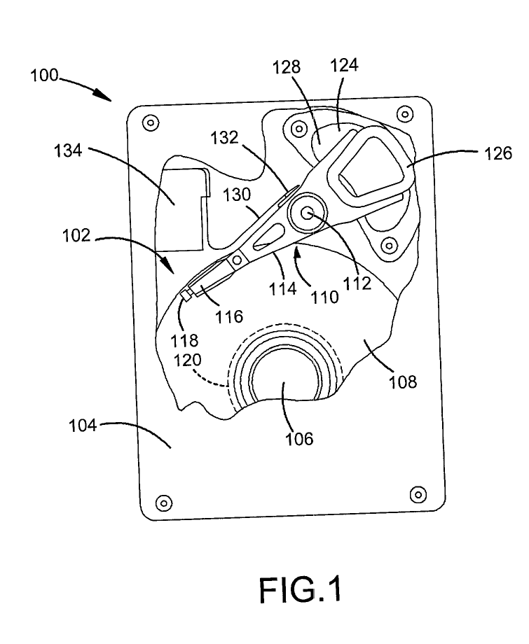

A disc drive 100 constructed in accordance with a preferred embodiment of the present invention is shown in FIG. 1. The disc drive 100 includes a base 102 to which various components of the disc drive 100 are mounted. A top cover 104, shown partially cut away, cooperates with the base 102 to form an internal, sealed environment for the disc drive in a conventional manner. The components include a spindle motor 106, which rotates one or more discs 108 at a constant high speed. Information is written to and read from tracks on the discs 108 through the use of an actuator assembly 110, which rotates during a seek operation about a bearing shaft assembly 112 positioned adjacent the discs 108. The actuator assembly 110 includes a plurality of actuator arms 114 which extend towards the discs 108, with one or more flexures 116 extending from each of the actuator arms 114. Mounted at the distal end of each of the flexures 116 is a head 118, which includes an air bearing slider enabling the head 118 to fly in close proximity above the corresponding surface of the associated disc 108.

During a seek operation, the track position of the beads 118 is controlled through the use of a voice coil motor (VCM) 124, which typically includes a coil 126 attached to the actuator assembly 110, as well as one or more permanent magnets 128 which establish a magnetic field in which the coil 126 is immersed. The controlled application of current to the coil 126 causes magnetic interaction between the permanent magnets 128 and the coil 126 so that the coil 126 moves in accordance with the well-known Lorentz relationship. As the coil 126 moves, the actuator assembly 110 pivots about the bearing shaft assembly 112, and the heads 118 are caused to move across the surfaces of the discs 108.

The spindle motor 116 is typically de-energized when the disc drive 100 is not in use for extended periods of time. The heads 118 are moved over park zones 120 near the inner diameter of the discs 108 when the drive motor is de-energized. The heads 118 are secured over the park zones 120 through the use of an actuator latch arrangement, which prevents inadvertent rotation of the actuator assembly 110 when the heads are parked.

A flex assembly 130 provides the requisite electrical connection paths for the actuator assembly 110 while allowing pivotal movement of the actuator assembly 110 during operation. The flex assembly includes a printed circuit board 132 to which head wires (not shown) are connected; the head wires being routed along the actuator arms 114 and the flexures 116 to the heads 118. The printed circuit board 132 typically includes circuitry for controlling the write currents applied to the heads 118 during a write operation and a preamplifier for amplifying read signals generated by the heads 118 during a read operation. The flex assembly terminates at a flex bracket 134 for communication through the base deck 102 to a disc drive printed circuit board (not shown) mounted to the bottom side of the disc drive 100.

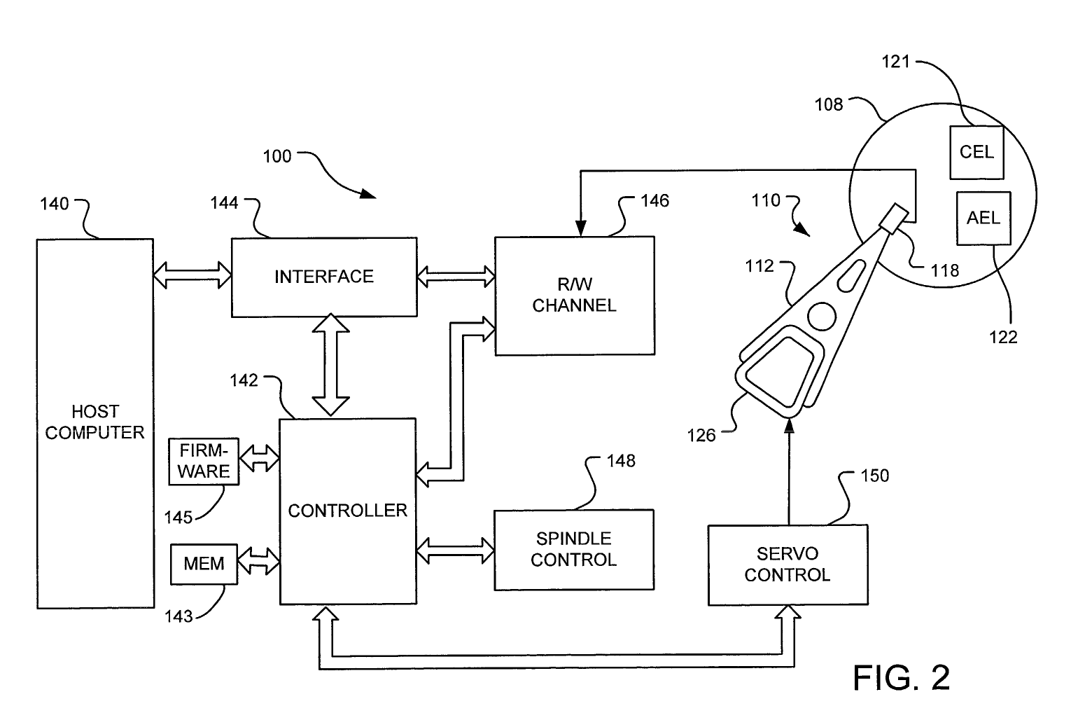

Referring now to FIG. 2, shown therein is a functional block diagram of the disc drive 100 of FIG. 1, generally showing the main functional circuits that are resident on the disc drive printed circuit board and used to control the operation of the disc drive 100. The disc drive 100 is shown in FIG. 2 to be operably connected to a host computer 140 in which the disc drive 100 is mounted in a conventional manner. Control communication paths are provided between the host computer 140 and a disc drive controller 142. The controller 142 generally provides top level communication and control for the disc drive 100 in conjunction with programming for the controller 142 stored in a controller memory (MEM) 143 and/or a firmware 145.

The MEM 143 can include random access memory (RAM), read only memory (ROM), and other sources of resident memory for the controller 142. The firmware 145 is a programming module typically included into a ROM 145 that is operably connected to the controller 142. The firmware 145 can be installed in the ROM using a disc drive interface 144, can be distributed like other software modules, and further can be created and tested by using microcode simulation. The firmware 145 is often a key component of the disc drive operation, because it contains the software program for disc drive operations that could be independent from the control of the host 140.

The discs 108 are rotated at a constant high speed by a spindle control circuit 148, which typically electrically commutates the spindle motor 106 (FIG. 1) through the use of back electromotive force (BEMF) sensing. During a seek operation, the track position of the heads 118 is controlled through the application of current to the coil 126 of the actuator assembly 110. A servo control circuit 150 provides such control. During a seek operation the microprocessor 142 receives information regarding the velocity and acceleration of the head 118, and uses that information in conjunction with a model, stored in memory 143, to communicate with the servo control circuit 150, which will apply a controlled amount of current to the voice coil motor 126, thereby causing the actuator assembly 110 to be pivoted.

Data is transferred between the host computer 140 and the disc drive 100 by way of the disc drive interface 144, which typically includes a buffer to facilitate high speed data transfer between the host computer 140 and the disc drive 100. Data to be written to the disc drive 100 are thus passed from the host computer to the disc drive interface 144 and then to a read/write channel 146, which encodes and serializes the data and provides the requisite write current signals to the heads 118. To retrieve data that has been previously stored by the disc drive 100, read signals are generated by the heads 118 and provided to the read/write channel 146, which performs decoding and error detection and correction operations and outputs the retrieved data to the interface 144 for subsequent transfer to the host computer 140.

Generally, the disc drive interface 144 is hardware and/or software that regulates transmission of data and manages the exchange of data between the disc drive 100 and the host computer 140. This disc drive interface 144 is contained in the electronics of the disc drive 100. A standard committee such as American National Standard Institute (ANSI) oversees the adoption of an interface protocol by which any peripheral device following the common standard can be used interchangeably. Programming of the firmware 145 follows the disc drive interface protocol.

There are various types of disc drive interface standards such as Small Computer Systems Interface (SCSI), FibreChannel-Arbitrated Loop (FC-AL), Serial Storage Architecture (SSA), Advanced Technology Attachment (ATA), Integregrated Device Electronics (IDE), CompactFlash, etc. In an embodiment of the present invention, the ATA interface standard is used as an interface between the host computer 140 and the disc drive 100. However, it is well known to those skilled in the art that the same scope and spirit disclosed in an embodiment of the present invention can also be applied to other types of disc drive interfaces listed above.

The ATA interface is the official ANSI standard designation for the interface between a disc drive and a host computer. Generally, the ATA standard specification deals with the power and data signal interfaces between the motherboard in the host computer and the disc controller in the disc drive. The ATA interface is primarily used in single host computer applications and usually supports one or two disc drives, generally known as a master and slave disc drives (or alternatively disc drives 0 and 1).

The ATA disc drives are known to be quite reliable but they may fail occasionally. A disc drive failure may be costly and time consuming when the associated host computer is also down while the disc drive is being replaced. Since the stored data may be lost unless the disc drive was backed up shortly prior to the disc drive failure, it may also be costly. A disc drive failure however could be predictable or unpredictable. An unpredictable disc drive failure is a sudden, unforeseen failure often due to uncontrollable external circumstances such as a power surge. A predictable disc drive failure is due to normal wear and tear of the electrical and mechanical disc drive components during normal disc drive operations. This means that some attributes of electronic or mechanical components can be monitored and that a predictive failure analysis is thus possible. Generally, mechanical component failures are predictable and account for sixty percent of all types of drive failures although certain electronic component show signs of degradation before failing. For example, monitoring the degradation of head flying height may detect a potential head crash.

In order to prevent such loss of time or data due to a disc drive failure, a new reliability prediction technology known as SMART was developed. SMART is a reliability prediction technology for predicting or anticipating a failure for disc drives generally operating under both ATA/IDE and SCSI environments. SMART, for example, upon anticipating a disc drive failure, would provide a sufficient notice that allows a user to schedule replacement of a worn-out disc drive or that allows a user or a system to backup data. SMART technology, originally pioneered by Compaq Computers, is under continued development by the top disc drive manufacturers in the world.

SMART monitors a series of attributes that are indicators of an electronic or mechanical component failure. These attributes are chosen specifically for each individual disc drive model since drive architectures vary from one model to another. Attributes and thresholds that may be a failure indicator for one disc drive model type may not be true for another model type. SMART cannot predict all possible disc drive failures. Rather, SMART is an evolving technology that helps to improve the ability to predict reliability of disc drives. Thus, subsequent changes to SMART attributes and threshold have been made based on various field experiences.

SMART generates alarm signals (e.g., in response to SMART “report status” command), and the software on the host computer 140 interprets the alarm signals. The host computer 140 polls the disc drive 100 on a regular basis to check the status of this “report status” command, and if the command signals imminent failure, the host computer 140 sends an alarm to the end user or the system administrator. This allows scheduling of a downtime for backup of data and replacement of the disc drive.

Most of the programming for the SMART technology resides in the disc drive firmware 145. In order to access the data in the firmware 145 collected by SMART, an engineer uses a set of the ATA commands since the disc drive and the host computer are operably connected by the ATA disc drive interface. The disc drive firmware 145 and/or controller 142 perform most operations for collection and processing of the SMART data and post the result to the host computer 140 indicating whether a disc drive failure is imminent.

SMART—a technology developed primarily for predicting disc drive failures—has undergone vast improvements since the inception. For example, SMART Error Logging is an extension of the SMART technology for reporting a record of the most recent errors reported by the disc drive 100 to the host computer 140. An error arises when the disc drive 100 fails to perform a command (e.g., a read or write command) issued by the host computer 140. Such an error is then recorded by the SMART Error Logging technology. This information collected by SMART Error Logging is primarily used by engineers during a disc drive development phase in order to quickly identify and fix design problems before similar disc drives are mass produced.

SMART was developed as a tool for predicting a disc drive failure by collecting the disc drive attributes and analyzing them while the disc drive is in normal use. However, the data collected by SMART is inadequate for analyzing root causes of disc drive failure. Because SMART was so focused on predicting a disc drive failure, the data collected by SMART did not contain other related useful information that may be useful for analyzing the disc drive failure. More specifically, the data related to the attributes collected by SMART did not contain enough details needed for conducting a successful failure analysis, although the collected data may be adequate for failure prediction. Further, some attributes important for a failure analysis were not recorded by SMART if those attributes were not useful for failure prediction.

For example, the SMART technology for predicting a disc drive failure may typically record the frequency and severity of the following attributes as indicators for disc drive reliability (although the attributes are disc drive specific): head flying height, data throughput performance, spin-up time, reallocated sector count, seek error rate, seek time performance, spin try recount, drive calibration retry count, etc. The frequency and severity of occurrences of these attributes are important criteria for determining a disc drive failure. However, for analyzing a root cause of a disc drive failure, an engineer conducting the failure analysis would require information that shows what happened to the disc drive while the disc drive was in normal operation. A time stamp for each occurrence of event, for example, would be a great tool for understanding the past of the failed disc drive, but SMART did not record the time aspect of the recorded event or error. To illustrate, SMART may record one attribute, the reallocated sector count (e.g., the sector with a particular PCHS address was reallocated ten times prior to the disc drive failure), but captures no information as to when each sector reallocation occurred (e.g., all ten sector reallocations occurred within ten seconds of each other, as opposed to each of the ten sector reallocations occurred at midnight of every tenth day). By analyzing the history of the disc drive in detail, the cause of the disc drive failure may be determined. Further, the analysis may reveal that the returned disc drive was mislabeled and that the perceived disc drive failure was caused by external devices outside the disc drive. Nevertheless, SMART did not provide enough details for the information that is useful for understanding the pathology of the failed disc drive. Moreover, the SMART may not record many types of events or errors unless each occurrence exceeds the established minimum threshold. Thus, there may have been many unrecorded notable occurrences useful for failure analysis because all fell short of the SMART threshold.

Further, SMART does not record many events that may not be useful for failure prediction but may be useful for failure analysis. For example, an event such as changing the disc drive setting from master to slave (or 0 to 1) would not be captured by the SMART since such an event has no bearing on determining the reliability of a disc drive or predicting a disc drive failure. An event is a disc drive operational occurrence that falls short of being an error (e.g., a successful sector reallocation). An error on the other hand arises when the disc drive could not successfully carry out a command issued by a host computer (e.g., a failure to write to a sector due to a failed sector reallocation).

Therefore, since knowing the history of the disc drive may be useful in determining the health of the disc drive, a Critical Event Log 121 and operations for determining the Critical Event Log is disclosed in an embodiment of the present invention. The Critical Event Log 121 contains historical information of the disc drive. Critical events are all disc drive operational events, errors, and/or other operational information that are useful for performing a more accurate analysis of a disc drive. Any occurrence of critical events is stored in the Critical Event Log 121. The Critical Event Log 121 is stored in dedicated sectors on the disc 108 inside the disc drive 100. The Critical Event Log 121 is updated in real time, and the logging operation is independent of the control of the host computer. The Critical Event Logging operations are transparent to a user. The information stored in the Critical Event Log 121 can be used to help determine the current health of the drive as well as provide information for disc drive failure analysis.

Whereas SMART was developed for predicting disc drive failures while the disc drive 100 is in operation with the host computer 140, a Drive Self-Test (DST) was developed for diagnosing root causes of disc drive failures or suspected disc drive problems for a failed disc drive. For example, upwards of forty-percent of all supposedly failed disc drives returned to a disc drive manufacturer such as Seagate Technologies are tested with the DST and are determined to be fully operational disc drives. The DST tests the operational status of the reportedly failed disc drive and determines whether it is likely that there have been some other causes for the disc drive return, such as a virus infection or a software bug. The DST is stored as a part of the firmware 145 of the disc drive 100. Generally., an engineer would run the DST of the returned disc drive and would have the firmware 145 post the result to the host as to whether or not the disc drive has actually failed.

The DST is a set of disc drive diagnostics tests or routines built into the firmware of every modern hard drive. These tests are invoked by a DST-aware diagnostic software application that resides on the host computer. One example of this software is SeaTools® drive diagnostic software from Seagate Technologies.

The ATA-5 specification describes two levels of diagnostic tests that a host computer can instruct a disc drive to execute: Short DST and Enhanced DST. The Short DST is a two-minute test targeted at quickly determining the operational status of the drive. As a part of the test, the Short DST reads at least the first 1.5 gigabytes of the disc drive. The Short DST has an accuracy of about 60-70%. Thus, if a disc drive was found to be operational after the DST Quick Test, the Enhanced DST was needed to verify whether the disc drive is indeed failed. Unlike the Short DST, the Enhanced DST completely scans the disc drive media. The time required to complete the Enhanced DST depends on the capacity of the disc drive, but it is considerably longer than the time required to complete the Short DST. While the Enhanced DST has an accuracy rate of 95%, the test requires approximately one minute for each gigabyte measured. With today's rapidly increasing areal densities, the Enhanced DST creates downtime issues that could impact the decision to run a diagnostic routine on disc drives.

The Enhanced DST is capable of accurately distinguishing good disc drives from bad disc drives; however, it cannot execute the test quickly enough for frequent use. As described above, the Enhanced DST takes approximately one minute for every gigabyte of disc space. The Short DST takes less than two minutes but unfortunately tends to indicate an unacceptable number of false negatives (i.e. bad disc drives being reported as good disc drives).

An embodiment of the present invention provides a diagnostics test for disc drives that can be performed within a short amount time with high accuracy comparable to that of the Enhanced DST. Therefore, Enhanced Short DST is disclosed in an embodiment of the present invention that, inter alia, significantly improves the accuracy rate of the Short DST to that of the Enhanced DST (i.e., 95% accuracy). With Enhanced Short DST, disc drives suspected of problems can be reliably and accurately tested in less than two minutes. In less than two minutes, the cause of the disc drive problems—whether the disc drive itself or something else in the system is causing problems—can be identified. Thus, the Enhanced Short DST helps to minimize unnecessarily replacing good disc drives.

The Enhanced Short DST breaks the mold of traditional diagnostics test for disc drives that executes the test generally when it is instructed by a host computer. Disc drives that are capable of executing the Enhanced Short DST continuously log errors that are discovered during normal host-directed read and write commands. An error arises when a command issued by the host computer cannot be performed by a disc drive. This error is then stored in an ATA Error Log (also known as an ATA SMART Error Log), located on sectors of the disc drive that are inaccessible to the end-user. The ATA Error Log is an industry standard ATA-5 protocol and describes how a disc drive should record a historical log of failed drive commands.

In addition to logging errors in the ATA Error Log, disc drives capable of executing the Enhanced Short DST will log a variety of additional noteworthy events that are not recorded in the Critical Event Log. An example of an event that are recorded in the Critical Event Log are sectors read that required an extraordinary number of error recovery steps to read the data. Additionally, disc drives capable of performing the Enhanced Short DST will re-read previously written sectors to ensure the data is recoverable. Under rare circumstances, data that is written is not recoverable because of events like “spliced writes” caused by a microscopic particle temporarily coming between the head and the media. The disc drive will execute the Seagate Write Authentication Tests (SWAT) to verify that data is being recorded correctly. Any SWAT failures will be recorded in the Critical Event Log. Finally, recorded with each event in the Critical Event Log is a timestamp, type of error, logical block addresses, the temperature of the hard drive at the time of the event, and other useful information for conducting a disc drive failure analysis. This diagnostic activity happens in the background transparently to the user, and does not significantly affect the hard drive performance.

These disc drives capable of executing Enhanced Short DST logs a complete picture of errors, events, and other disc drive activities that may be useful for conducting a disc drive failure analysis. When the host computer initiates the Enhanced Short DST, the drive firmware does not have just rely on run-time diagnostics of the drive but can utilize the historical logs stored in the disc drive that records error events while the drive is executing read, write and other commands from the host computer. In a sense, the disc drives capable of running the Enhanced Short DST are continuously running diagnostics tests without a host computer intervention, for example, by leveraging the normal reads and writes by the host computer during normal disc drive operations.

When a diagnostic software application commands a disc drive to run the Enhanced Short DST, the disc drive first runs a short list of diagnostics ensuring the basic functionality of the drive and then inspects the history logs for previously detected errors, events, and other operational information. This breakthrough in diagnostics capability greatly reduces the number of false negatives reported by the previous Short DST. In sum, under the Enhanced Short DST, the Short DST is essentially expected to have the effectiveness of the Enhanced DST—detecting a failed disc drive in about two minutes with an approximately 95 percent accuracy.

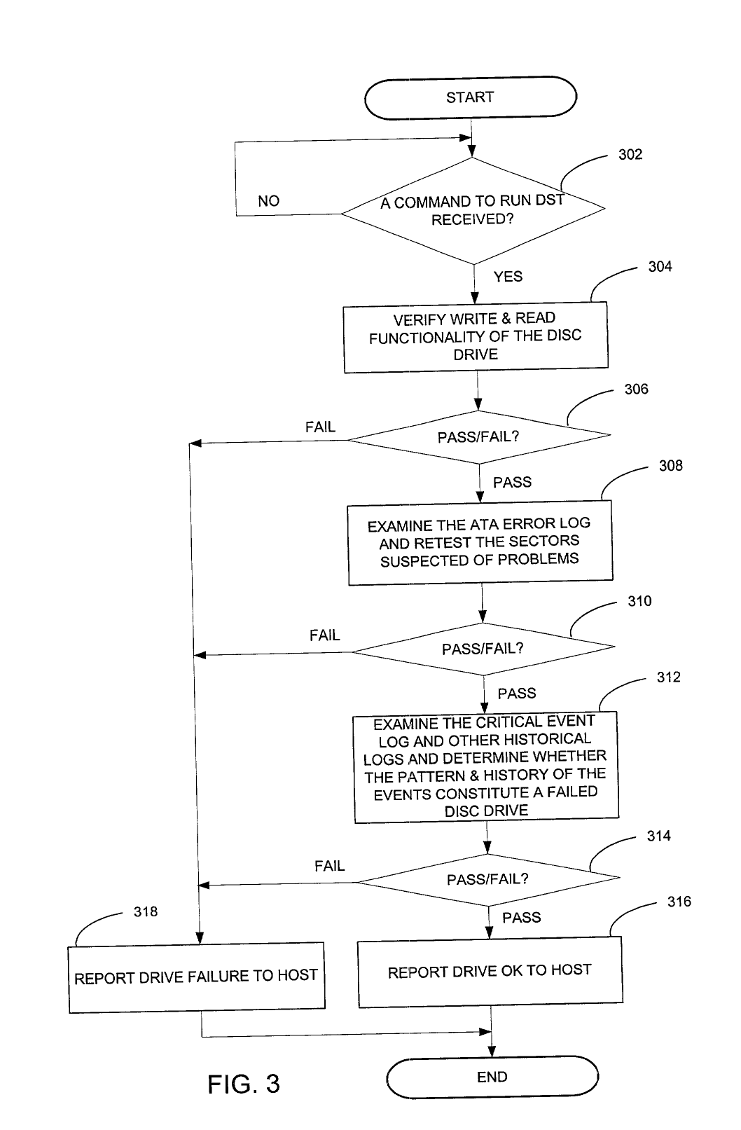

Shown in FIG. 3 is a flowchart for running the Enhanced Short DST. The programming routines for the Enhanced Short DST is stored inside the firmware 145 of the disc drive 100. The host computer 140 can run the Enhanced Short DST by issuing a command such as “execute device diagnostics” command defined by the ATA-5 protocol to the disc drive 100. In operation 302, the DST programs routine in the firmware 145 waits for the command from the host computer 140 to run the Enhanced Short DST. If the command is received in operation 302, the Enhanced Short DST initiates the test by first verifying proper write and read functionality of the disc drive 100 in operation 304. If the Enhanced Short DST determines in operation 306 that the disc drive 100 cannot properly perform read or write operations due to, for example, defects in the head 118, the servo control 150 or the read or write channel 146, the Enhanced Short DST then reports to the host computer 140 in operation 318 and ends the test. If the write/read functionality of the disc drive is determined satisfactory in operation 306, the Enhanced Short Test then examines the ATA Error Log in operation 308. The firmware 145 continuously records failed read or write commands issued by the host into the ATA Error Log. In operation 308, the Enhanced Short DST then retests the failed command by reading the sectors that were in question. If there were a considerable number of unrecoverable bad sectors, the Enhanced Short DST determines whether or not the disc drive is a bad or failed disc drive in operation 310. If the disc drive is determined a good disc drive in operation 310, the Enhanced Short DST examines the Critical Event Log 121 and other historical logs, if there are any additional logs, and determines whether or not the failure patterns recorded in the Critical Event Logs and other historical logs constitute a failed disc drive in operation 312. As described above, the firmware 145 would have recorded unusual events including the events or errors detected due to SWAT failure in the Critical Event Log. If the Enhanced Short DST determines in operation 314 that the disc drive 100 is a bad drive in operation 314, the Enhanced Short DST then reports to the host computer 140 in operation 318 and ends the test. The pass/fail criteria of disc drives used in operations 301, 310 and 314 are predefined in the Enhanced Short DST, and the criteria can vary from one model type to another. If the Enhanced Short DST determines that the disc drive is a good drive in 314, it is reported to the host computer 140 in operation 316, and the test ends.

Disc drives with Enhanced Short DST feature are capable of logging errors and events related to the disc drive operation. Further, the disc drives with the Enhanced Short DST feature have the Enhanced Short DST diagnostic modules embedded in the firmware 145 of the disc drive 100. The Enhanced Short DST diagnostic modules perform diagnostics tests whenever information stored in the disc drive is accessed by other computer modules such as an operating system and/or a programming application. Further, the Enhanced Short DST embedded in the firmware continuously logs any error or events related to operations or performance of the disc drive during on-line (i.e., the information in the disc drive is accessed by the host computer 140) and off-line mode.

The errors discovered by the disc drives with Enhanced DST feature are logged in the ATA Error Log on the disc. The ATA Error Log sectors on the disc generally are not accessible by a user although the user may read the sector but may not write to the sector. In addition to logging errors in the ATA Error Log, the disc drives with Enhanced DST feature log additional noteworthy events to the Critical Event Log. For example, it is a noteworthy event to record in the Critical Event Log if the disc drive had to perform an extraordinary number of error recovery steps to read a particular sector. Further, the SWAT verifies that data is being correctly written to a sector. Any SWAT failure is then recorded in the Critical. Event Log. These logging and diagnostics activities occur in the background and are transparent to a user and do not significantly affect the disc drive performance.

In summary, an embodiment of the present invention may be viewed as a method of diagnosing a disc drive failure (such as 302-318). A disc drive (such as 100) is operably connectable to a host computer (such as 140). The disc drive (such as 100) has a data storage disc (such as 108). A portion of the disc is a Critical Event Log storage area (such as 121) for storing a Critical Event Log and another portion being an ATA Error Log storage area (such as 122) for storing an ATA Error Log.

The method of diagnosing a disc drive failure (such as 302-318) involves receiving a “run diagnostics test command” from the host computer (such as 302) and, upon receiving the command, performing a disc drive diagnostic test that determines a disc drive failure by examining data stored in at least the Critical Event Log (such as 312-314) and the ATA Error Log (such as 308-310). The Critical Event Log (such as 121) records a critical event generated during a normal disc drive operation. A critical event is predefined information related to disc drive operations. The Critical Event Log (such as 121) further records information reported by a SWAT. The SWAT transparently performs self-authentication of data written to the data storage disc and reports information characterizing failed read commands. The ATA Error Log (such as 122) records errors generated when the disc drive unsuccessfully performs a command issued by the host computer (such as 140) and immediately reports the error to the host. The Critical Event Log (such as 121) is transparently generated during on-line data collection mode and off-line data collection mode. Further, the Critical Event Log (such as 121) and the ATA Error Log (such as 122) are generated by firmware (such as 145) of the disc drive (such as 100) without host computer intervention.

It will be clear that the present invention is well adapted to attain the ends and advantages mentioned as well as those inherent therein. While a presently preferred embodiment has been described for purposes of this disclosure, various changes and modifications may be made which are well within the scope of the present invention. Numerous other changes may be made which will readily suggest themselves to those skilled in the art and which are encompassed in the spirit of the invention disclosed and as defined in the appended claims.

What is claimed is:

1. In a disc drive operably connectable to a host computer, the disc drive having a data storage disc, a portion of the disc being a critical event log storage area for storing a critical event log and another portion being an advanced technology attachment (ATA) error log storage area for storing an ATA error log, a method of diagnosing a disc drive failure comprising steps of:
(a) receiving a run diagnostics test command from the host computer; and
(b) upon receiving the command, performing a disc drive diagnostic test that determines a disc drive failure by examining data stored in at least one of the critical event log and the ATA error log.

2. The method according to claim 1 wherein the critical event log records a critical event generated during a normal disc drive operation, wherein the critical event is predefined information related to disc drive operations.

3. The method according to claim 2 wherein the critical event log further records information reported by a write authentication test (SWAT), wherein the SWAT transparently performs self-authentication of data written to the data storage disc and reports information characterizing failed write commands.

4. The method according to claim 3 wherein the ATA error log records errors generated when the disc drive unsuccessfully performs a command issued by the host computer.

5. The method according to claim 4 wherein the critical event log is transparently generated during on-line data collection mode and off-line data collection mode.

6. The method according to claim 5 wherein the critical event log and the ATA error log are generated by firmware of the disc drive without host intervention.

7. A computer readable media readable by a computer and encoding instructions for executing the method recited in claim 6.

8. A disc drive operably connectable to a host computer, the disc drive having a data storage disc, a portion of the disc being a critical event log storage area for storing a critical event log and another portion of the disc being an advanced technology attachment (ATA) error log storage area for storing an ATA error log, the disc drive comprising:
a disc drive interface providing a data communication path between the disc drive and a host computer; and
an Enhanced Short Disc Drive Self-Test (Enhanced Short DST) module for performing Enhanced Short DST upon receiving a run diagnostics command from the host computer, wherein the module is operably connected to the data storage disc and the disc drive interface.

9. The disc drive of claim 8 wherein the Enhanced Short DST module is embedded in firmware of the disc drive.

10. The disc drive of claim 8 wherein the Enhanced Short DST module determines a disc drive failure by examining data stored in at least one of the critical event log and the ATA error log.

11. The disc drive of claim 10 wherein the critical event log records a critical event generated during a normal disc drive operation, wherein the critical event is predefined information related to disc drive operations.

12. The disc drive of claim 11 wherein the critical event log further records information reported by a write authentication test (SWAT), wherein the SWAT transparently performs self-authentication of data written to the data storage disc and reports information characterizing failed write commands.

13. The disc drive of claim 12, wherein the ATA error log records errors generated when the disc drive unsuccessfully performs a command issued by the host computer.

14. The disc drive of claim 13, wherein the critical event log is transparently generated during on-line data collection mode and off-line data collection mode.

15. The disc drive of claim 14, wherein firmware generates the critical event log and the ATA error log without host computer intervention.

16. A disc drive operably connectable to a host computer, the disc drive having a data storage disc, a portion of the disc being a critical event log storage area for storing a critical event log and another portion of the disc being an advanced technology attachment (ATA) error log storage area for storing an ATA error log, the disc drive comprising:
a disc drive interface providing a data communication path between the disc drive and a host computer; and
means for performing Enhanced Short Disc Drive Self-Test (Enhanced Short DST) upon receiving a run diagnostics command from the host computer.

17. The disc drive of claim 16 wherein the disc drive interface is an ATA disc drive interface.

18. The disc drive of claim 16 wherein the Enhanced Short DST determines a disc drive failure by examining data stored in at least the critical event log and the ATA error log.

19. The disc drive of claim 18 wherein the critical event log records a critical event generated during a normal disc drive operation, wherein the critical event is predefined information related to disc drive operations.

20. The disc drive of claim 19 wherein the critical event log further records information reported by a write authentication test (SWAT), wherein the SWAT transparently performs self-authentication of data written to the data storage disc and reports information characterizing failed write commands.

21. The disc drive of claim 20, wherein the ATA error log records errors generated when the disc drive unsuccessfully performs a command issued by the host computer.

22. The disc drive of claim 21, wherein the critical event log is transparently generated during on-line data collection mode and off-line data collection mode.

23. The disc drive of claim 22, wherein firmware generates the critical event log and the ATA error log without host computer intervention.
